(19) United States
(12) Patent Application Publication
(10) Pub. No.: US 2014/0188709 A1
(43) Pub. Date: Jul. 3, 2014

(54) Process for Delivering Trusted Services

(71) Applicant: Charles D. Brown, Woodinville, WA (US)

(72) Inventor: Charles D. Brown, Woodinville, WA (US)

(21) Appl. No.: 14/142,676

(22) Filed: Dec. 27, 2013

Related U.S. Application Data
(60) Provisional application No. 61/747,189, filed on Dec. 28, 2012.

(51) Int. Cl. G06Q 20/22

(52) U.S. Cl. CPC G06Q 20/29
USPC 705/39

(57) ABSTRACT

A professionalized cash management service for the event community consolidating a plurality of individual merchant accounts into a master TPS account, aggregating a plurality of transactions to obtain substantial discounts on transaction fees, and sharing discounts with the merchants. The service delivers a fully automated, centrally controlled payment processing service to festivals and merchants with minimal overhead.

### CROSS REFERENCE TO RELATED APPLICATIONS

This application claims priority to the following U.S. Provisional Patent application which is hereby incorporated by this reference as if fully set forth herein: 61/747,189 filed Dec. 28, 2012

### TECHNICAL FIELD

This disclosure relates to a professionalized cash management service for the event community.

### BACKGROUND

There are approximately 30,000 events in the U.S. annually with an estimated one billion visitors. At a given time there are about 22,000 active events (73% of annual total) with an estimated combined total of 700,000,000 visitors. Consumer spending at festivals and events is estimated to total $50 billion dollars annually. It is estimated that 85% of transactions and 60% of this annual volume is in cash, with little if any penetration by transaction processing services (TPS).

Festivals currently charge merchants 10% to 25% commissions on sales. Festivals need a TPS because the commissions on sales of food and merchandise can account for as much as 50% of the events' total revenue and their under-reporting of sales is believed to be wide spread. Assuming merchants may under-report by as much as 10%, the average revenue slippage per festival can be estimated as between $50,000 and $100,000. To overcome this problem, some festivals have gone so far as to produce “funny money” alternatives to cash which they deploy at their events.

There are a number of problems with this approach. The most notable issues are consumer dissatisfaction, counterfeiting, and theft. As a result, these types of deployments are not common. A recent survey of 220 producers who manage 1,627 festivals and events shows that 28% charge merchants a commission.

Festivals that do not charge commissions account for 72% of merchants today. The festivals that do not charge cite difficulty of administering commissions. Festivals in this category also need TPS as they are missing out on important revenues, but lack the administrative infrastructure to take on the task of administering the program and policing the collection of sales commissions. Festival and event producers in this category stand to make hundreds of thousands in commissions from use of an integrated TPS.

Festivals that do not charge lack economic motivation. Festivals in this group (less than 10% of the total market and declining due to eroding funding support from municipal governments) have yet to see value in TPS.

Today's fair managers and festival producers are not financial systems integrators. They do not have card processing systems and therefore have expensive consumer cash collections. They do not have ticket system integration, and therefore have to deal with vendor sales commission collections, cash storage, distribution and transportation. There are also problems with theft and with reconciliation.

Current Cash Alternatives

Tokens, Tickets, and Closed Loop Cards are cumbersome to deploy and collect, costly to manage, and there is risk of counterfeit and fraud, they are uninsurable. There are storage and security issues and it is frustrating for attendees. There are all the problems of cash, but without bank support.

### DISCLOSURE

### Value Proposition

The benefit to festivals is clear: deploy TPS and receive a significant increase in sales commissions, or an altogether new revenue stream. In addition to receiving more money, festivals will receive their cash the next business day, including accurate sales and commission reports on a merchant-by-merchant and a timeslot-by-timeslot basis.

While the festival and event producers can mandate the use of TPS, they have made it clear that onerous merchant terms must be avoided as they would produce excessive pushback by merchants. The disclosed TPS addresses this concern by consolidating the individual merchant accounts into a master TPS account that aggregates the transactions to obtain substantial discounts on transaction fees which are shared with the merchants.

Merchants will be offered four services options as follows:

1. Rental terminals for credit/debit processing on a per event basis

Class 1 is for merchants who do not have credit/debit processing equipment, are required by the festival producer to use TPS but who are not yet prepared to use the service on an ongoing basis, or lack the volume to purchase terminal equipment. Option 1 includes set up fees, terminal rental expense and higher merchant transaction fees.

2. Reprogramming of existing merchant terminals to work temporarily through the disclosed TPS.

Class 2 is for merchants who have their own equipment, are required by the festival to use TPS, but want to revert back to their current merchant services provider after the event.

3. Permanent reconfiguration of a merchant's existing terminals to work through TPS.

Class 3 is for merchants who have their own equipment and want to apply the benefit of TPS transaction discounts across their non-event (brick and mortar retail and website) credit and debit processing as well as at the event.

4. New equipment retained by the merchant for ongoing processing through TPS.

Class 4 is for merchants who want new equipment and option 3 discounts.

The goal is to stimulate rapid movement of merchants to options 3 and 4 wherein they benefit from lower TPS transaction fees at the event and within their brick and mortar and internet retail operations. The disclosed TPS benefits by running all of the merchant's transactions through the TPS regardless of where they originate.

The goal of the disclosed TPS operation is to deliver a fully automated centrally controlled payment processing service to festivals and merchants with minimal overhead.

The disclosed novel TPS operation is organized with financial industry partners such as Visa, Bank of America Merchant Services (BAMS), and First Data Corporation. It occupies a unique position: it has Master Merchant Authorization by Visa and MC.

The disclosed novel TPS operation provides an enhanced TPS, with online booth sales, online ticket and merchandise sales, and on-ground card processing. It also provides equipment and service for fair management and its vendors and provides cash management, sales commission administration, prepaid card-based cashless operations, ticketing, and ATM systems.

The disclosed enhanced TPS takes care of the Event, Registers it on FestBiz.com, sets up booth sales, gets event ID for vendors, and the Event's website is enabled for card processing.

The TPS takes care of Vendors, Registers them on FestBiz.com with event ID, buys booth space at FestBiz.com.

The TPS is also on the ground at the event with supplies and services terminals, and it processes all transactions through its processing partners. It reports sales and manages charge backs. See FIG. 1—Transaction Platform high level transaction flowchart.

How the TPS Booth Sales Work

Event sets fees online, the Event Issues code to vendors, vendors use code to register and apply for booth purchases online, Event approves purchase, the TPS deposits funds to Event account. See FIG. 2—Event Registration Worksheet.

How the TPS Consumer Purchases Work

Event receives terminals, Vendors receive terminals, Consumers make purchases, TPS receives and distributes funds less processing fees, TPS reports sales results. See FIG. 3—Sales and Transaction Report.

How Sales-Admin Works

Event sets commissions, TPS processes transactions, collects vendor sales results, deducts vendor commissions, transfers commissions to event, deposits remainder to vendor, collects vendor cash if needed, and reports online to both parties. See FIG. 4—Sales Admin Report.

Integrated Cashless Operations (Cash-In)

Visa prepaid cards are sold as tickets or companions, they are sold online, at event and via channel partners, providing more consumer revenue with value added benefits, more sponsorship revenue from post-event patronage. Like all Visa cards they are good anywhere Visa is accepted.

Cash-In: How it Works

Customer selects which benefits to add to prepaid card/ticket. The Event adds card benefits, sets benefit package price, selects card type, selects branding options, selects selling methods, projects revenue, and places order online See FIG. 5—Add Benefits selection screen, and FIG. 6—Cashless Operation Report.

### Enhanced TPS Operations Support

### Turn-Key Operations: Planning, Deployment, Execution, Reporting.

### Benefits:

Event: Increases revenue and profits, reduces cash risks, provides new business intelligence.
Consumer: Enhances the consumer experience, facilitates purchases, no breakage for the attendees.
Vendor: Improves vendor sales, reduces vendor transaction fees, provides new business Intelligence.

### BRIEF DESCRIPTION OF THE DRAWINGS

FIG. 1—Transaction Platform high level transaction flowchart

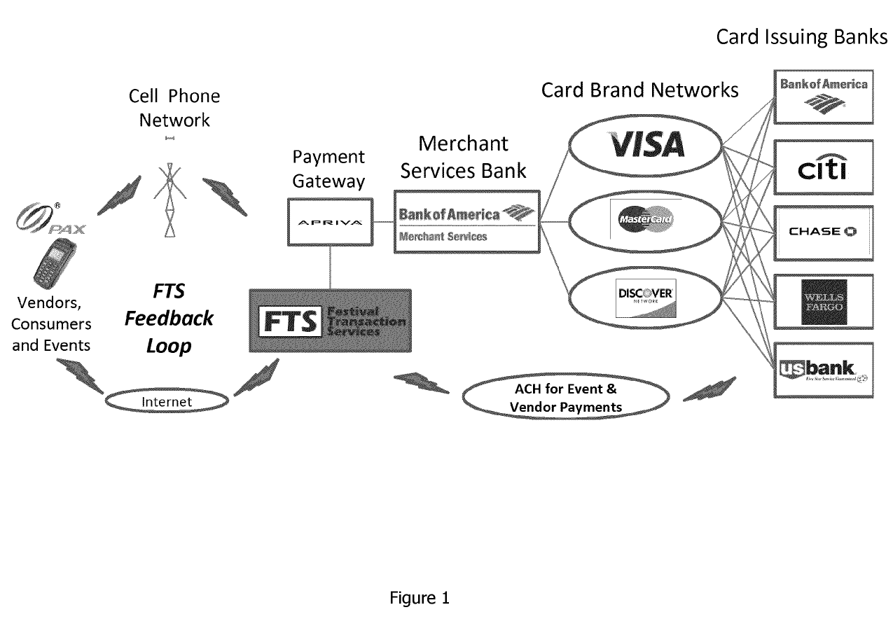

FIG. 2—Event Registration Worksheet

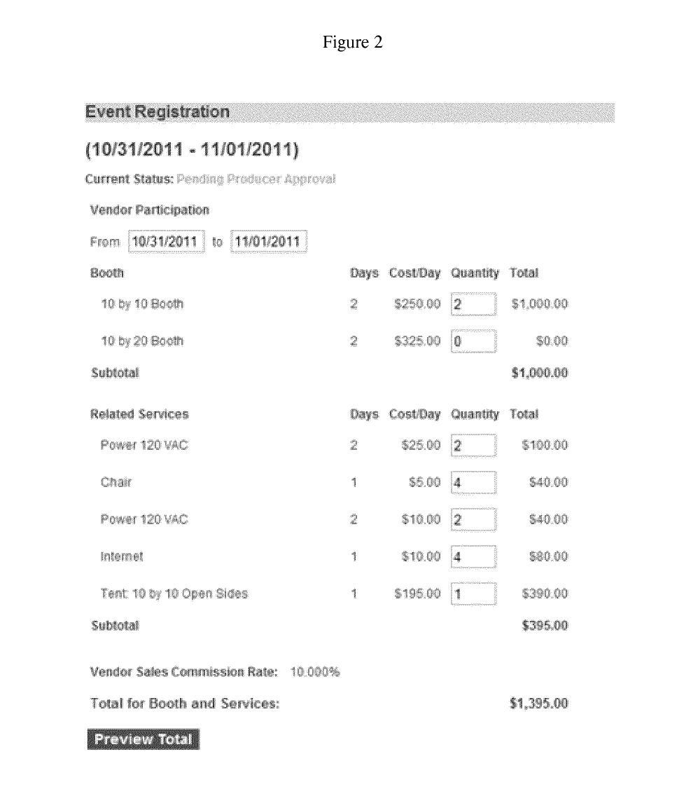

FIG. 3—Sales and Transaction Report

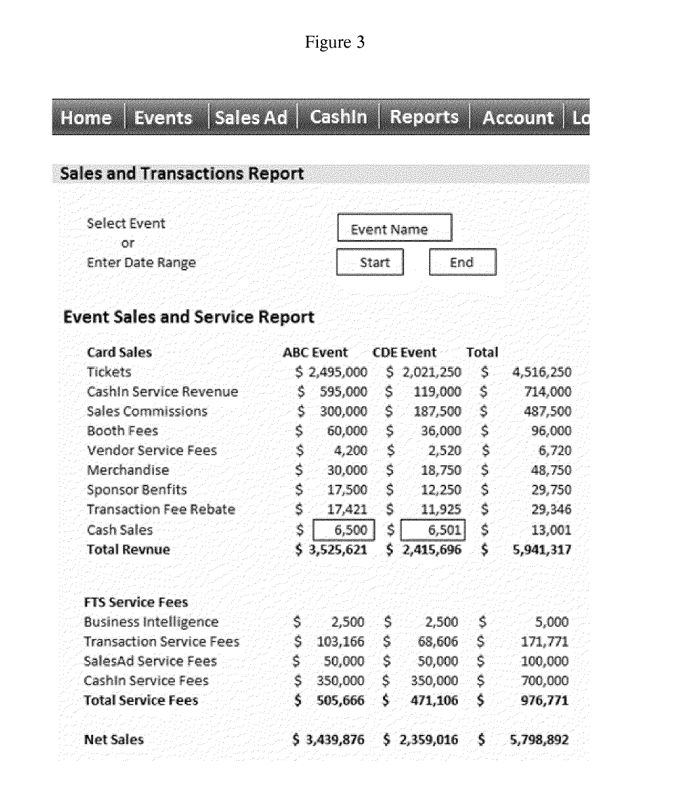

FIG. 4—Sales Admin Report

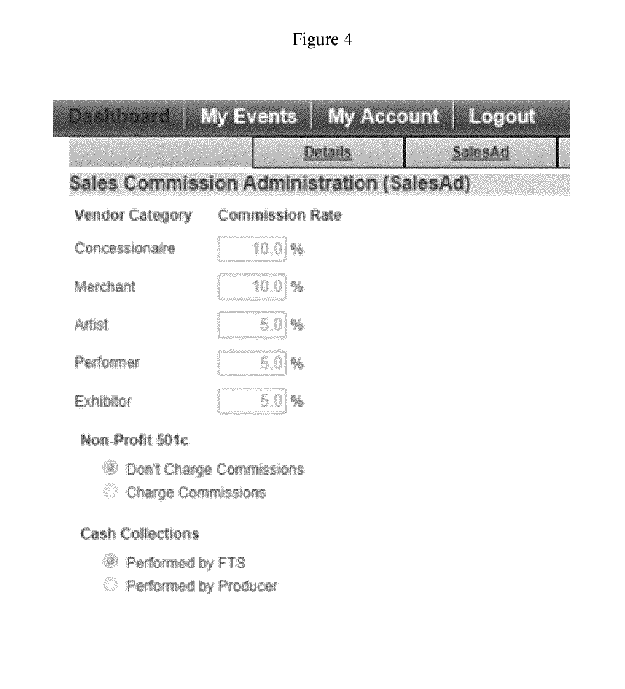

FIG. 5—Add Benefits selection screen

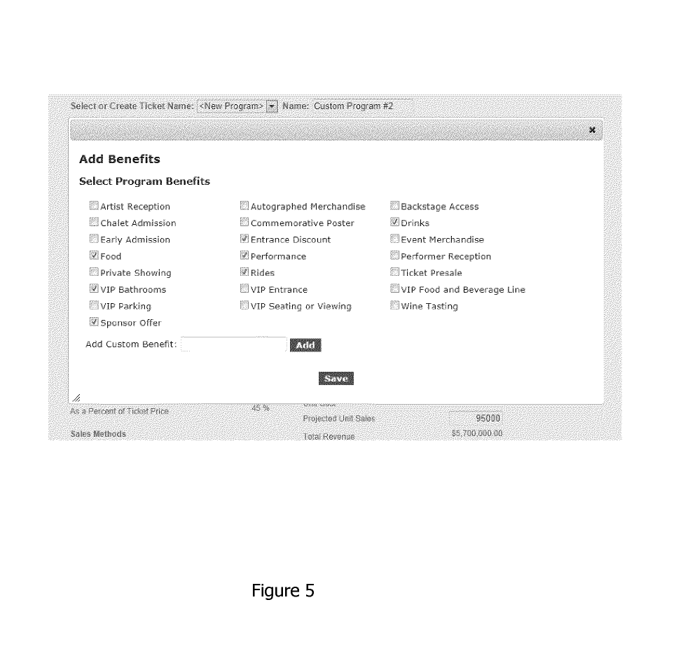

FIG. 6—Cashless Operation Report

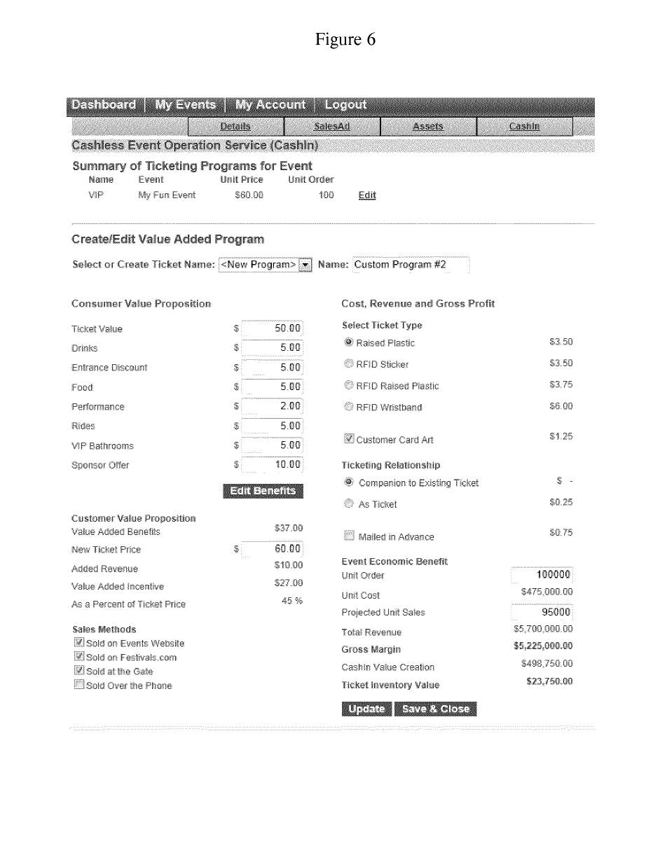

I claim:

1. A method of providing professionalized cash management service for the event community comprising the steps of: consolidating a plurality of individual merchant accounts into a master TPS account, aggregating a plurality of transactions to obtain substantial discounts on transaction fees, sharing discounts with the merchants, wherein the method delivers a fully automated, centrally controlled payment processing service to festivals and merchants with minimal overhead.

2. The method of claim 1, further comprising an enhanced TPS, with online booth sales, online ticket and merchandise sales, on-ground card processing, equipment and service for fair management and its vendors and cash management, sales commission administration, prepaid card-based cashless operations and ticketing services.
